(19) United States
(12) Patent Application Publication
(10) Pub. No.: US 2009/0150800 A1
(43) Pub. Date: Jun. 11, 2009

(54) Apparatus, Method and Computer Program Product for Generating Debriefing Charts

(76) Inventors: Glenn Wood, Centreville, VA (US); Gary Cazenas, Herndon, VA (US)

Correspondence Address: SHAWNA J. SHAW, 15151 STRATTON MAJOR CT., CENTERVILLE, VA, 20120, US

(21) Appl. No.: 12/328,220

(22) Filed: Dec. 4, 2008

Related U.S. Application Data
(60) Provisional application No. 60/992,701, filed on Dec. 5, 2007.

(51) Int. Cl. G06F 15/16

(52) U.S. Cl. 715/751

(57) ABSTRACT

An apparatus, method, and computer program product for generating and displaying debriefing charts to authorized users. According to disclosed methods, debriefing charts are generated by obtaining summarized evaluation data; formatting the summarized data according to predetermined settings; and generating slides or pages using the formatted data. In some cases, custom debriefing charts may be generated e.g., based upon user authorization level. The apparatus includes a debriefing tool that may be standalone or integrated with a proposal evaluation tool using appropriate APIs, plug-ins, etc. The debriefing tool includes a plurality of modules including e.g., an evaluation data acquisition module, a formatting module, a debriefing chart generating module, a display module, and a user interface module.

### BACKGROUND OF THE INVENTION

This application claims benefit to U.S. Provisional Application No. 60/992,701 filed Dec. 5, 2007, the entire contents incorporated herein by reference.

1. Field of the Invention

The present disclosure pertains generally to communicating evaluation data. More specifically, the present disclosure relates to generating debriefing charts for authorized users.

2. Discussion of Related Art

Part of any selection process includes some form of conscious, or subconscious, scoring or ranking of factors amongst applicants. Ranking factors may include, for example, cost, performance, experience, and other specific criteria. Final selections of “winner(s)” are typically performed by totaling scores and choosing the applicant(s) with the highest “overall ranking.” This type of selection process is sometimes called best value determination, lowest cost determination, etc., and generally applies to choosing candidates for: jobs, bids, projects, sports teams, schools, and more. Oftentimes, (especially in a competitive selection process) it is also useful to provide comments to support, supplement, and/or interpret the rankings assigned to various factors. Comments provided along with rankings help to provide information for: further characterizing and/or distinguishing between applicants, providing supporting evidence, explaining the rankings, providing helpful feedback, etc. In some cases, comments may become part of an official record and be relied upon in case of subsequent challenges e.g., from non-selected candidates.

There may also exist different audiences to whom the evaluation information needs to be communicated. For example, it may be necessary or desirable to explain the rationale for candidate selection to internal management, while on the other hand it may be necessary to provide useful feedback to candidates, etc. For example regarding proposal selection, it would be valuable for e.g., non-winning vendors to receive specific reasons why their proposal was not selected so as to aid in the preparation of future proposals. Quick dissemination of useful feedback to vendors in this manner results in better quality proposals in the future, which in turn, improves competition and enhances the value of the overall procurement process.

Currently, there exists a need in the art for automatically generating and displaying debriefing charts that present summarized evaluation data in an accurate and easy to understand format. There also exists a need to automatically generate custom debriefing charts for appropriate users, for example based upon user authorization level. Moreover, there exists a need for generating debriefing charts in a quick and cost effective manner.

### SUMMARY OF THE INVENTION

The present disclosure addresses current needs in the art and provides an apparatus, method, and computer program product for automatically generating and displaying debriefing charts for authorized users.

According to a first aspect, a computerized method is disclosed for generating and displaying a debriefing chart to authorized user(s) for a proposal selection process in which one or more winning proposal(s) are selected from a group of submitted proposals, the method comprising: using a first processor to obtain summarized evaluation data for one or more of the proposals; using a second processor to format the summarized data according to predetermined settings; using a third processor to generate a debriefing chart using the formatted, summarized data; and displaying the generated debriefing chart to authorized user(s).

According to a second aspect, a computer program product is disclosed that is disposed on a computer readable medium and containing instructions, that when executed by a computer, cause the computer to generate, store and/or display a debriefing chart to authorized users, the instructions comprising: obtaining summarized evaluation data; formatting the summarized data according to predetermined settings; generating a debriefing chart using the formatted, summarized data; and displaying the debriefing chart to authorized users.

According to a third aspect, a computerized debriefing tool is disclosed for generating and displaying a debriefing chart to authorized user(s) for a proposal selection process in which one or more winning proposals are selected from a group of submitted proposals, the debriefing tool comprising: a first processor that obtains summarized evaluation data for one or more of the proposals; a second processor that formats the summarized data according to predetermined settings; a third processor that generates a debriefing chart using the formatted, summarized data; and a display that displays the generated debriefing chart to authorized user(s).

### BRIEF DESCRIPTION OF THE DRAWINGS

FIG. 1 illustrates a system according to one aspect of the disclosure.

FIG. 2 illustrates method steps for generating debriefing charts according to one exemplary embodiment of another aspect of the disclosure.

FIG. 3 illustrates method steps for generating debriefing charts according to another exemplary embodiment of the disclosure.

FIGS. 4a-d illustrate method steps for debriefing chart generation according to yet another exemplary embodiment of the disclosure.

FIGS. 5a-c illustrate a debriefing tool according to an aspect of the disclosure.

FIGS. 6a-d depict various debriefing chart slides generated and displayed according to embodiments disclosed herein.

### DETAILED DESCRIPTION OF PREFERRED EMBODIMENTS

Reference will now be made in detail to various exemplary embodiments of the present disclosure. The following detailed description is provided to better illustrate certain details of aspects of the preferred embodiments, and should not be interpreted as a limitation on the scope or content of the disclosure. In general, the present disclosure describes an apparatus, method, and computer program product for generating debriefing charts for authorized users. The principles disclosed herein may be used to create debriefing charts for proposal selection, product or service selection, candidate selection (e.g., for jobs, sports teams, schools, etc.), and/or any other uses where creation of a debriefing chart for supporting and/or justifying a decision would be useful. Although debriefing charts for proposal selection will be described below by way of example, it will further be appreciated that debriefing charts for other selection processes will be deemed to fall within the spirit and scope of the present invention.

As used herein, “a” means one or more; “user” includes any applicant, candidate, vendor, bidder, evaluator (e.g., source selection team member or internal management), or any other individual involved in a selection process; “evaluation data” includes qualification data, rating data, comment data, cost data, risk data, consensus data, or any other data which is useful for performing evaluations; “debriefing chart” includes any combination of one or more page(s) or slide(s) of: graphs, charts, figures, statements, lists, outlines, or any other visual means for communicating summarized evaluation data in a meaningful and easy to understand manner; “data source” includes any one or more sources of evaluation data including: datastore(s), database(s) (object oriented or relational), and/or data file(s). Such file(s) include, but are not limited to, .xls, .doc, .XML, HTML, or proprietary types of files (e.g., consensus evaluation reports), etc.

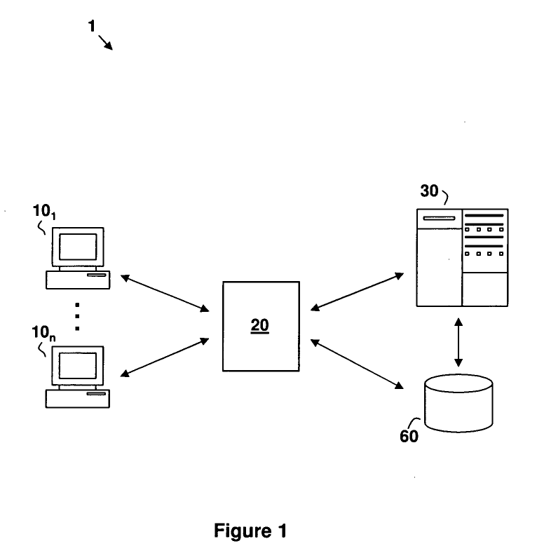

FIG. 1 illustrates a system 1 according to one aspect of the disclosure including one or more user computers 10₁₋ₙ connected to one or more server(s) or host machine(s) 30 over a communications network 20. User(s) may include, for example, proposal evaluators or source selection team members, internal management, proposal submitters, vendors, etc. A user computer 10 may comprise one or more PCs, laptops, handheld devices, workstations, and the like. A user computer 10 typically includes a display, keyboard, pointing device, one or more processors (including an operating system), internal memory (e.g., RAM, ROM, etc.), and storage media. Examples of storage media include any fixed or removable devices such as hard drives, CDs, DVDs, magneto-optical storage, memory cards, memory sticks, and the like. Preferably, the user computers 10₁₋ₙ have access to a Web browser (such as Internet Explorer 5.5 or higher, Netscape 6 or higher, Mozilla 1.0 or higher, Safari, or any other browser capable of supporting JavaScript™ (by Sun Microsystems, Inc., Santa Clara, Calif.) and CSS level 1). The server(s) or host machine(s) 30 may comprise, for example, a Pentium 4 processor (2.5 GHz or higher) with at least 1024 MB RAM and 20 GB hard drive. Preferably, the server(s) or host machine(s) 30 run applications such as Jakarta (by the Apache Software Foundation, Forest Hill, Md.), Apache Tomcat (by the Apache Software Foundation, Forest Hill, Md.), BEA Weblogic™ (by BEA Systems, Inc., San Jose, Calif.), MySQL™ (by MySQL AB Cupertino, Calif.), MS SQL Server™ (by Microsoft Corp., Redmond, Wash.), Oracle™ (by Oracle Corp., Redwood Shores, Calif.), etc.

According to various embodiments, the server(s) or host machine(s) 30 are located either proximate or remote with respect to user computer(s) 10₁₋ₙ. Therefore, the network 20 may include any combination of: intranets, extranets, the Internet, LANs, MANs, WANs, or the like, and may be further comprised of any combination of: wire, cable, fiber optic, mobile, cellular, satellite, and/or wireless networks. For example, if a user is part of the source selection team or internal management, the server(s) or host machine(s) 30 will typically be located in the same floor or building as the user (in which case the network 20 might comprise a LAN and/or intranet). On the other hand, if the user is a vendor, the server(s) or host machine(s) 30 are usually located remote to the vendor, and the network 20 might comprise an extranet, Internet, LAN, MAN, WAN, etc.

FIG. 1 also shows one or more data source(s) 60 in operative communication with server(s) or host machine(s) 30. In embodiments, the data source(s) 60 comprise datastore(s) and/or database(s) that provide evaluation data for different proposals in a searchable and flexible manner. Database(s) such as MySQL™, MS SQL Server™, Oracle™, etc. may be used to sort and filter the evaluation data according to various characteristics and/or groupings as will be appreciated by those skilled in the art. For example, evaluation data may be sorted by strengths, weaknesses, costs, risk level, and so forth, for each evaluation factor. According to embodiments, the data source(s) 60 are in operative communication with server(s) or host machine(s) 30 by means of: network 20, local connection(s), internal memory, APIs, plug-ins, etc.

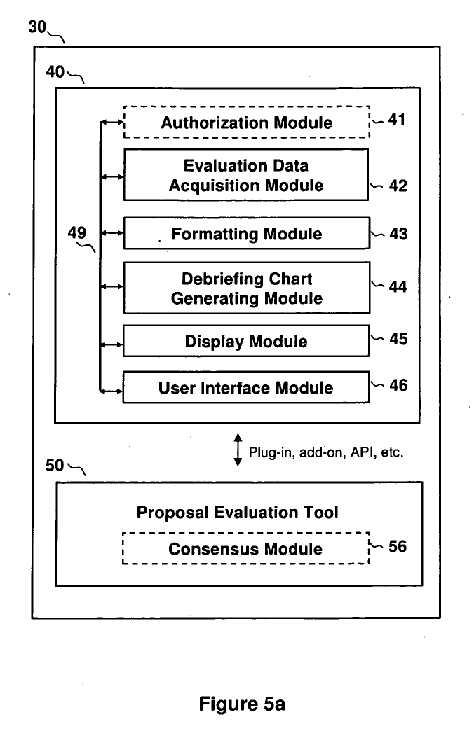

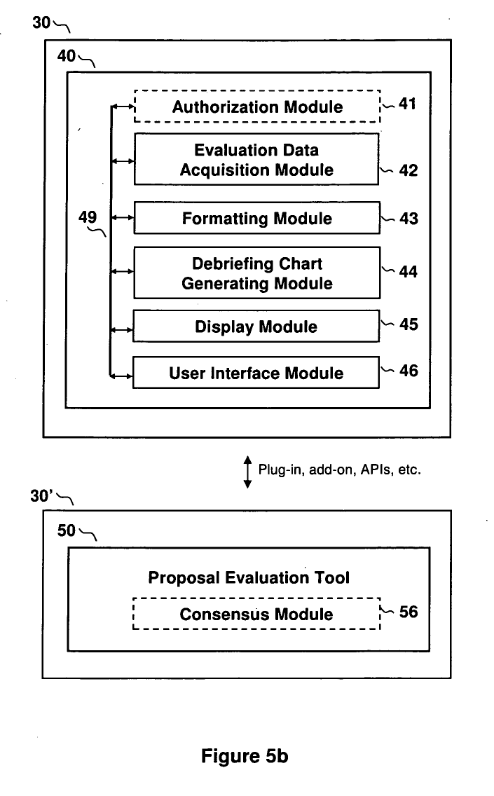

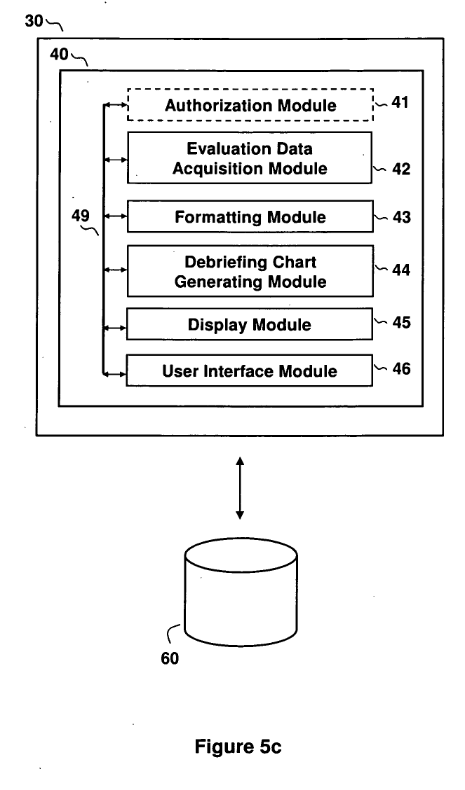

Turning to FIGS. 5a and b, a Web-based debriefing tool 40 resides on the one or more server(s) or host machine(s) 30 and, in embodiments, is associated with a Web-based proposal evaluation tool 50 via e.g., a flexible plug-in architecture. Although illustrated on the same server or host machine 30 in FIG. 5a, it is understood that in other embodiments, the debriefing tool 40 and proposal evaluation tool 50 are located on different, server(s) or host machine(s) 30 and 30′ (see FIG. 5b).

Thus, it is understood that according to various embodiments, the debriefing tool 40 is standalone and accesses evaluation data in the data source (e.g., datastore, database, data file, etc.) 60 directly; standalone and accesses evaluation data in the data source (e.g., datastore, database, data file, etc.) 60 through another application's (such as a proposal evaluation tool's) API; or embedded in another tool (such as a proposal evaluation tool, etc.).

Although illustrated separately in FIG. 1, it is understood that the one or more data source(s) 60 may either be integral with, or separate from: server(s) or host machine(s) 30, proposal evaluation tool 50 and/or debriefing tool 40. Thus, according to one non-limiting example, the proposal evaluation tool 50 and/or data source(s) 60 reside on one server or host machine 30′ (not shown) and the debriefing tool 40 on server or host machine 30. In this case, the debriefing tool 40 may access proposal evaluation data on server or host machine 30′ e.g., through an API, etc. According to another non-limiting example, the proposal evaluation tool 50 and/or data source(s) 60 residing on server or host machine 30′ accesses the debriefing tool 40 on server or host machine 30 via a plug-in, API, add-on, etc. According to yet another non-limiting example, the debriefing tool 40 is a standalone application residing e.g., on server or host machine 30. In this case, the debriefing tool 40 may access data source(s) 60 directly apart from a proposal evaluation tool 50. For example, the debriefing tool may comprise a Web-based user interface that prompts the user for an input data file. An input data file, such as an existing consensus evaluation report and/or any other type of file, (e.g., .doc, .xls, HTML, XML, etc.) containing evaluation data is selected and the evaluation data contained therein used to generate a debriefing chart. In embodiments, an application (such as POI by the Apache Software Foundation, Forest Hill, Md.) reads a file (e.g., a consensus evaluation report on a local hard drive of user computer 10) and automatically creates a debriefing chart for display. Such an application may include a command-line executable or batch program that is invoked with arguments specifying a datastore (e.g. input file, database, etc.) containing evaluation data to be read by the application for generation and display of debriefing charts.

In further embodiments, the debriefing tool 40 and/or proposal evaluation tool 50 are database driven such that changes to evaluation data enable corresponding changes to be made to the debriefing chart on-the-fly. This may be done, for example, by rerunning the debriefing tool such that modified data from the database is used to re-generate the debriefing chart or at least corresponding portions of the debriefing chart on-the-fly.

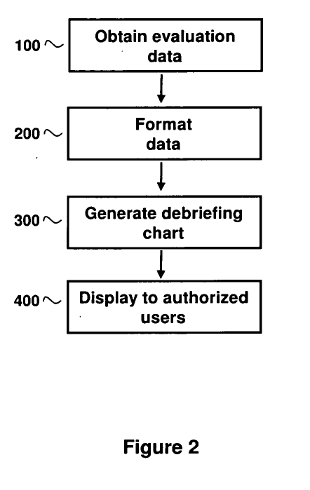

FIGS. 2-4 illustrate exemplary method steps that are implemented to generate debriefing charts. Preferably, the disclosed method steps are implemented in whole, or in part, using appropriately configured software tools (such as Java™, JavaScript™, Java™ APIs, MySQL™, MS SQL Server™, etc.) as will be appreciated by those skilled in the art. In addition, it is recognized that the method steps illustrated or discussed in the present disclosure may be performed in different sequences and are therefore not limited to the order presented.

In step 100 of FIG. 2, evaluation data is obtained. Evaluation data may comprise, for example, evaluation comment data, consensus data, rating data, and/or price data with respect to one or more vendors. In embodiments, evaluation comment data further includes information regarding strengths, weaknesses, rating intensity (e.g., excellent, good, fair, poor), level of risk (e.g., high, medium, low), etc., for each evaluation factor and/or sub-factor. In further embodiments, summarized consensus data may be obtained e.g., using a proposal evaluation tool 50 such CASCADE (by Best Value Technology, Inc., Haymarket, Va.) that combines comments from individual evaluators to provide summarized consensus data that may be easily incorporated into debriefing charts.

According to various embodiments, evaluation data may be obtained from: in-house proposal evaluation data source(s), external proposal evaluation data source(s), data files (e.g., .xls, .doc, XML, HTML, proprietary formats, etc.), or any other source(s) of evaluation data. In some cases, evaluation data may be entered manually into the debriefing tool by authorized users, such as source selection team members, internal management, etc. It will be appreciated that a user can be authorized according to various levels as determined e.g., by a system administrator, as will be appreciated by those skilled in the art.

In step 200, the evaluation data is formatted according to predetermined settings appropriate for generating debriefing charts. Typically, the originally obtained evaluation data will not be in the necessary format required for generating the debriefing chart. For example, the evaluation data may be obtained in 12 point Times New Roman font (or, in some cases, not even associated with a particular font). However, if the debriefing chart is to be generated for a slideshow presentation, it may be necessary to convert to a larger size font. Other settings for the debriefing chart may include predetermined: page width, page height, margins, main font type, main font size, font and background color, custom icons, templates, etc. depending upon the particular application. Additionally or alternatively, evaluation data may be formatted for subsequent display on one or more page(s) or slide(s) according to content-specific parameters such as: ‘ShowCostData’=true/false (to generate cost comparison slide(s)); ‘ShowWinner’=true/false (to generate slide(s) indicating the selected proposal(s)); ‘JustShowFactors’=true/false (to generate slide(s) showing factors); etc. Other content-specific parameters include: strengths, weaknesses, vendor information, cost data, and any additional parameters useful for a debriefing.

According to step 300, debriefing chart pages are generated by creating an object and writing the formatted evaluation data to the object. Preferably, debriefing page(s) are created using a Java™ API (such as POI by the Apache Software Foundation or other proprietary or custom APIs). Such APIs may be used to automatically generate page(s) or slide(s) in PowerPoint™, Word™, Excel™, Visio™, .pdf format, etc. For example, PowerPoint™ slides are created using a POI-HSLF function call such as ‘SlideShow.createSlide ( )’. For other types of page(s), function calls from POI-HSSF, POI-HWPF, POI-HDGF, etc. may be used. Vendor and/or evaluation data may then be read e.g., from relevant data source(s) 60, formatted, and written to one or more pages of the debriefing chart. Moreover, pages created in one format may later be converted or generated to another format. For example, PowerPoint™ pages may be converted to .pdf pages using appropriate APIs, etc. as will be appreciated by those skilled in the art. When all the pages have been created, a file may be opened (e.g., using Java™), the debriefing pages written to the file, and the file closed to create the complete debriefing chart.

According to further embodiments, custom debriefing charts are generated in step 300 for different applications and/or users. For example, if the user is part of the source selection team or internal management, a debriefing chart is generated with evaluation data for all vendors. On the other hand, if the user is a vendor, a debriefing chart may be generated with only evaluation data regarding the proposal submitted by that vendor. In other embodiments, debriefing charts are generated for vendors that present overall evaluation data from all vendors (e.g., for comparison purposes) by filtering out sensitive or proprietary information using custom rules, filters, etc. to protect the privacy of individual vendors.

At step 400, the generated debriefing chart is output to a display (see for example, user computer 10 in FIG. 1). It is to be noted that the debriefing chart may be displayed in a variety of formats, including but not limited to, display on computer terminal(s) or monitor(s), hand-held display(s), overhead display(s), display on printout(s) from a printer, and/or output to data file(s) for storage on a computer-enabled media.

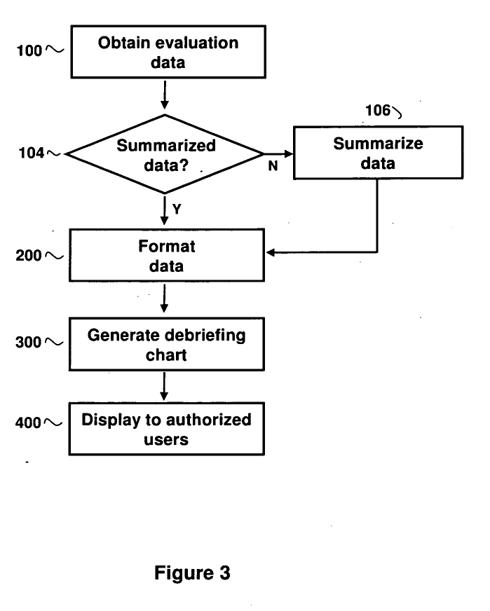

FIG. 3 illustrates flowchart method steps, according to yet another embodiment. Steps 100 and 200-400 are similar to those described in FIG. 2, however step 104 determines whether the evaluation data has been previously summarized. In some cases, evaluation data may have been previously summarized, for example using proposal evaluation tools (such as CASCADE that combines comments from individual evaluators to provide summarized consensus data that may be easily incorporated into debriefing charts). If the evaluation data has not been summarized, the data is summarized, for example, according to predetermined parameters, at step 106. Examples of predetermined parameters include predetermined number of words, keyword concentration, and so forth. The data may be summarized using a variety of techniques including: truncation after a predetermined number of words, automatic summary tools (such as ‘Auto-summarize’ by Microsoft™), application of custom rules, filtering out superfluous words, etc. Additionally and/or alternatively, an evaluator or source selection team member may manually summarize and/or edit the data before continuing the process. After summarized data has been obtained, the process continues to steps 200-400 as described previously with respect to FIG. 2.

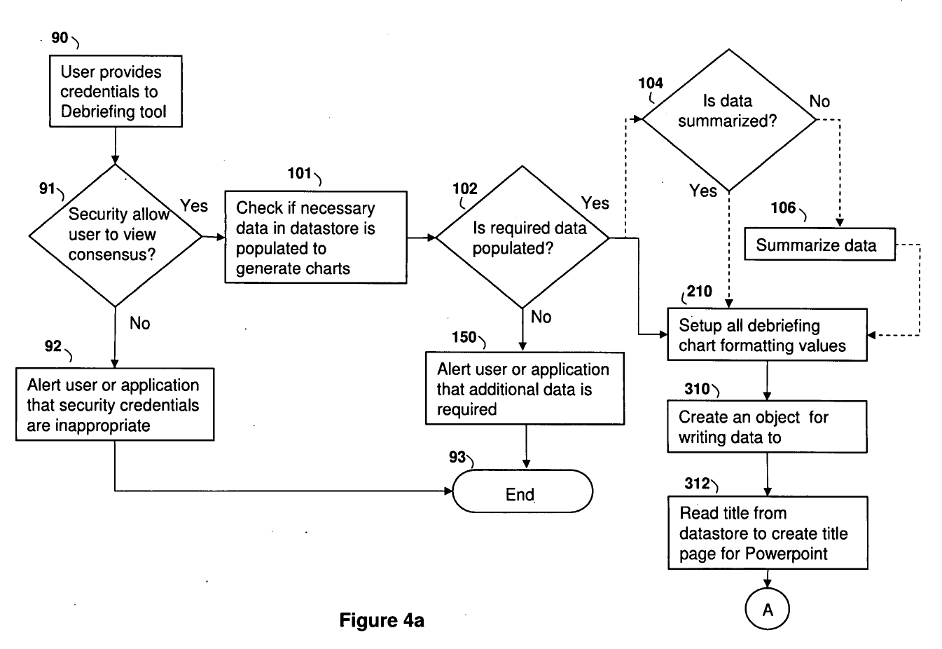

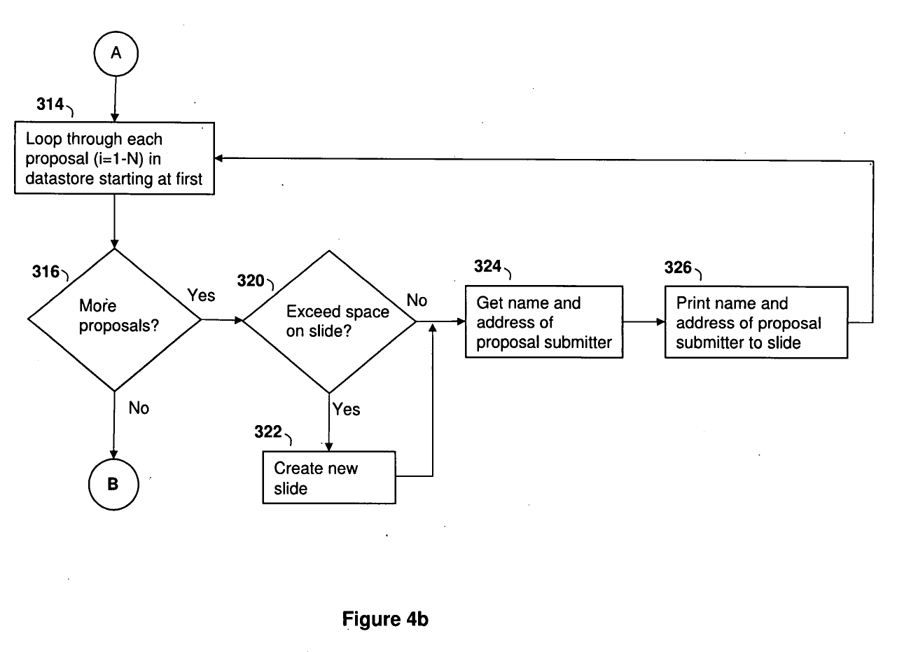

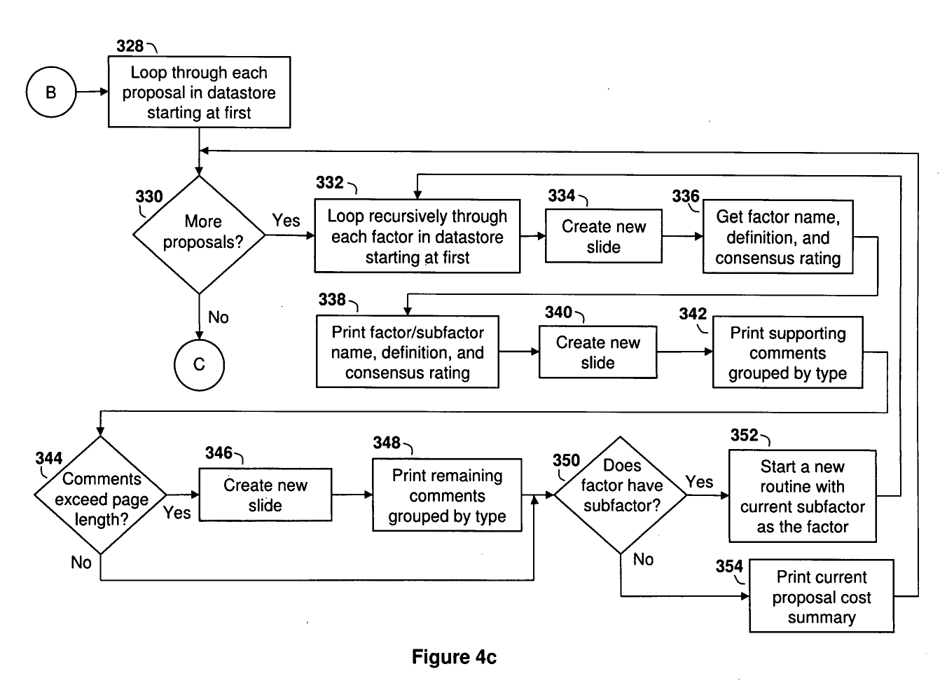

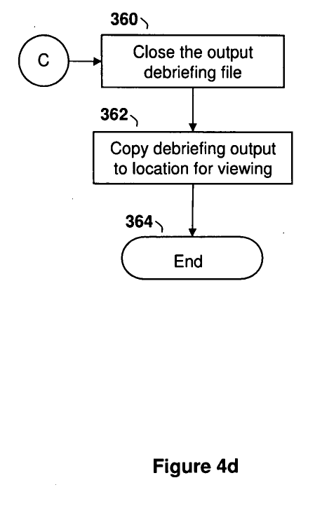

FIGS. 4a-d illustrate method steps for generating debriefing charts according to yet another exemplary embodiment of the disclosure. In step 90 of FIG. 4a, the user encounters an optional log-in page associated with the debriefing tool 40 and/or proposal evaluation tool 50 (residing e.g., on server 30) and enters user credentials (e.g., username/password, digital certificate, and the like). At step 91, the log-in page determines whether the user possesses appropriate credentials to view the evaluation data. If it is determined that the user is not authorized to view the evaluation data, the user and/or application are alerted that the security credentials are insufficient at step 92 and the process is ended at step 93. If the user possesses appropriate authorization credentials, the process goes to step 101.

Steps 101 and 102 check to see whether the required data in the data source 60 is populated to generate a debriefing chart. If the required data is not populated, the user and/or application are alerted at 150 that additional information is required and the process is ended at step 93. (At this point, the source selection team may be notified and/or prompted to enter the necessary data). For example, steps 101 and 102 may require that: evaluation data has been populated for all candidates (e.g., vendors); as much data has been generated as possible; the evaluation data has been run through consensus; and/or the evaluation data has been summarized—before the evaluation data can be used for generating a debriefing chart.

According to one embodiment (depicted by dashed lines in FIG. 4a), a determination is made at step 104 whether the evaluation data has been summarized. This determination may be made according to several factors such as length (e.g., number of words), concentration of key words, etc. If the evaluation data has not been summarized, the data is summarized at step 106. In embodiments, the data may be summarized using a consensus module (e.g., 56 in FIG. 5). Additionally and/or alternatively, the data may be summarized by the debriefing tool (40, see FIG. 5) e.g., according to predetermined parameters. Examples of predetermined parameters include predetermined number of words, keyword concentration, and so forth. The data may be summarized using a variety of techniques including: truncation after a predetermined number of words, automatic summary tools (such as “Auto-summarize” by Microsoft™), application of custom rules, filtering out superfluous words, and others. In some cases, an evaluator may go back and manually summarize the data before continuing or restarting the process. In another embodiment (depicted by solid lines in FIG. 4a), it is known that the evaluation data is already summarized, and the process goes to step 210. Such previously summarized evaluation data may be obtained e.g., from proposal evaluation tools such as CASCADE that combine comments from individual evaluators to provide summarized consensus data that may be easily incorporated into debriefing charts.

When the required evaluation data has been obtained, predetermined formatting values are set for the debriefing chart at step 210. As will often be the case, the obtained evaluation data will not be in the necessary format required for generating debriefing charts. For example, the evaluation data may be obtained in 12 point Times New Roman font, but if the debriefing chart is to be generated for a slide show presentation for a large audience, it may be necessary to convert to a larger font size. Other default variables for the debriefing slides may include: page width, page height, margins, font type, font size, font and background color, styles, custom icons, templates, etc. depending upon the specific application.

In step 310, an object for writing data into is created using e.g., an API or Java™ API (such as POI by the Apache Software Foundation). For example, to create a PowerPoint™ object using POI-HSLF, a function call such as ‘SlideShow ss=new SlideShow( )’ may be used. Continuing with the PowerPoint™ example, a title is read from the data source 60 in step 312 to create a main title page slide e.g., according to predetermined margin or template settings, and the process then moves to A.

FIG. 4b shows a loop whereby information from the proposals (such as vendor names and addresses) are obtained from data source 60 and written to object slide(s) according to predetermined settings beginning in step 314. The process is generally performed by starting at the first proposal (i=1) in the data source 60 and subsequently looping through each proposal (i). As part of each loop, a determination is made at 320 whether the information for the current proposal (i) exceeds the space allotted for that slide. If it does, new slide(s) are created at step 322 for the remaining information. At 324, the name and address of each submitter of the proposal is obtained and printed to the slide(s) (step 326). The process is repeated for the next proposal at 314. When it is finally determined at step 316 that no more proposals exist, the loop ends and the process continues to B.

FIG. 4c shows another loop whereby evaluation data for each tree level factor (if applicable) is obtained for each proposal and written to slides of the object. Beginning at step 328, evaluation data for each proposal (i=1 to N) is obtained from data source 60. Step 330 determines whether more proposals containing evaluation data exist. If another proposal is present, each factor/sub-factor definition and rating for that proposal is obtained and printed to slide(s) between steps 332-352.

In particular, at step 334 a new slide is created for each factor/sub-factor using a function call such as ‘SlideShow.createSlide ( )’. The factor/sub-factor name, definition and/or consensus rating are obtained from the datastore at 336 and printed to the slide at 338. In step 340, a new slide is created and summarized evaluation data printed to the slide, e.g., grouped by type, at 342. For example, comments may be grouped and displayed by comment type (such as strengths, weaknesses, etc.). At 344, a determination is made as to whether the evaluation data exceeds the space provided. If the space is exceeded, a new slide is created at 346 and the remaining data printed to the new slide 348. At step 350, a further determination is made as to whether any sub-factors exist, and if so, step 352 begins a new routine with the current sub-factor as the factor and the process moves to 330. If it is determined in step 350 that no sub-factors are present, a current proposal cost summary is printed at 354 and the process returned to step 330. When it is eventually determined at 330 that no more proposals exist, the loop is ended and the process directed to C.

Turning to FIG. 4d, the object slides are saved to a file as the complete debriefing chart and the file closed at 360. According to one example, a Java™ file is opened, the object (e.g., SlideShow( )) is sent to the file, and the file is closed. At step 362, the debriefing chart is copied to a location for viewing. In embodiments, the debriefing chart may be copied to a Web server (e.g., 30 in FIG. 1) so that it can be downloaded and opened by authorized users. In some examples, the user is redirected to a URL pointing to the file location such that the file can be opened, e.g., in PowerPoint™, and displayed 422 via the browser of the user computer 10.

In some cases, modifications may be made to evaluation data from within the debriefing tool 40 and/or proposal evaluation tool 50 (e.g., if properly authorized). Evaluation data may be modified to correct errors, override comments, summarize comments, etc. Preferably, only properly authorized users are able to modify the evaluation data (this may be useful, for example, to avoid changes between the time evaluation data was entered during source selection and when the debriefing was displayed). As a result of making modifications to the evaluation data, corresponding portions of the generated debriefing chart may be re-generated on-the-fly. This may be done, for example, by automatically using modified data from the data source to generate corresponding portions of the debriefing file.

As shown in FIGS. 5a-c, the debriefing tool 40 and/or a proposal evaluation tool 50 may reside on one or more server(s) 30-30′. For example, FIG. 5a depicts where the debriefing tool 40 resides on the same server 30 as a proposal evaluation tool 50. In this case, the debriefing tool 40 may also be embedded within the proposal evaluation tool 50. FIG. 5b depicts a standalone debriefing tool 40 residing on server 30 and a proposal evaluation tool 50 on a separate server 30′. In this case, the debriefing tool 40 may indirectly access evaluation data from the proposal evaluation tool 50 through an API, plug-in, etc. FIG. 5c depicts a standalone debriefing tool 40 residing on server 30 that is able to directly access evaluation data from data source(s) 60 apart from a proposal evaluation tool 50. In this case, the debriefing tool 40 may comprise a Web-based user interface that prompts the user for an input data file. An input data file, such as an existing consensus evaluation report file, or any other type of file (e.g., .doc, .xls, HTML, XML, etc.) containing evaluation data is selected and the evaluation data contained therein used to generate a debriefing chart.

Preferably, the debriefing tool 40 comprises: an evaluation data acquisition module 42, a formatting module 43, a debriefing chart generating module 44, a display module 45, a user interface module 46, and any other additional modules useful for creating debriefing charts. According to embodiments, the modules may comprise hardware and/or software components such as one or more processors, instructions stored in memory, computer readable media, etc. Furthermore, it is understood that the functionality of the various modules may be separate or combined and may be executed by a single processor or multiple processors. Preferably, the debriefing tool 40 is able to access evaluation data from a proposal evaluation tool 50 and/or other data source(s) 60 including databases or data files (such as .xls, .doc., XML, HTML, etc.) to generate debriefing charts.

An optional authorization module 41 is configured to determine whether a user logging into the debriefing tool possesses appropriate security credentials to view the evaluation data, consensus data and/or debriefing chart as will be appreciated by those skilled in the art. If the authorization module determines that the user is not authorized, it is further configured to alert the user or application that the security credentials are inappropriate and to end the log-in process. In some embodiments, the authorization module 41 is not required, and therefore can be bypassed or turned “on” or “off” as necessary. For example, the authorization module 41 may not be required when generating debriefing slides from an input file or when the debriefing tool 40 is embedded within another tool and/or parent application. In other embodiments, the authorization module 41 is configured to control distribution of debriefing charts to vendors and/or tracks who accesses the charts.

The evaluation data acquisition module 42 is configured to obtain evaluation data from the data source 60 using e.g., function calls and/or APIs as will be appreciated by those skilled in the art. In embodiments, the evaluation data acquisition module 42 corresponds to a first processor that obtains summarized evaluation data. Evaluation data may include: comment data (summarized or non-summarized) cost data, ratings, or any other data relevant to the selection process. In some embodiments, the evaluation data acquisition module 42 is configured to check to see whether all of the data in the data source 60 is populated and meets predetermined conditions before generating a debriefing chart. For example, custom rules may be applied requiring that evaluation data has been: populated for all candidates (e.g., vendors), and run through consensus before it can be used for generating a debriefing chart. In embodiments, the evaluation data acquisition module 42 is further configured to determine whether the evaluation data is summarized, and if not, to summarize the evaluation data. This determination may be made according to several factors such as length (e.g., number of words), concentration of key words, etc. In some cases, the evaluation data may already be summarized. Evaluation data may be previously summarized, for example using proposal evaluation tools such as CASCADE that combine comments from individual evaluators to provide summarized consensus data that may be easily incorporated into debriefing charts. If the evaluation data has not been summarized, the module 42 is configured to summarize the data by: truncating the evaluation data after a predetermined word length; automatically summarizing the data (using tools such as ‘Auto-summarize’ by Microsoft™); applying custom rules; and/or filtering out superfluous words, etc. Additionally and/or alternatively, an authorized evaluator may go back and manually summarize the data.

The formatting module 43 is configured to set up predetermined debriefing chart formatting values. In embodiments, the formatting module 43 corresponds to a second processor that formats the summarized data according to predetermined settings. As mentioned, it will often be the case that the obtained evaluation data will not be in the necessary format for the debriefing chart. For example, the evaluation data may be obtained in 12 point Times New Roman font, but if the debriefing chart is to be generated for a slide show presentation, it may be necessary to convert to a larger font, etc. Other predetermined settings for the debriefing slides may include: page width, page height, margins, main font type, main font size, font and background color, custom icons, templates, etc. depending upon the particular application.

The debriefing chart generating module 44 is configured to create a new object for writing debriefing information to using e.g., an API or Java™ API such as POI (by the Apache Software Foundation). For example, to create a PowerPoint™ object to write data into using POI-HSLF, a function call such as ‘SlideShow ss=new SlideShow( )’ is used. In embodiments, the debriefing chart generating module 44 corresponds to a third processor that generates a debriefing chart using formatted, summarized data. According to preferred embodiments, the debriefing chart generating module 44 is configured to: create a main cover page in the debriefing file that indicates e.g., the title of the source selection; obtain and print the names and addresses of all who submitted proposals on separate pages or slides; obtain and print each evaluation factor/sub-factor on separate slides; and obtain and print corresponding summarized evaluation data such as strengths, weaknesses, costs, etc. in accordance with the methods described herein. In some embodiments, the debriefing chart generating module 44 is configured to generate one or more slides documenting the winners of the proposal selection process. According to other embodiments, evaluation data for same factors and different submitters may be displayed together for comparison purposes. In this case, it may be necessary to filter sensitive information out of the display such that the privacy of individual vendors is maintained. Moreover, pages created in one format may later be converted or generated to another format. For example, PowerPoint™ pages may be converted to .pdf pages using appropriate APIs, etc. When all the pages have been created, module 44 may further be configured to open a file (e.g., using Java™), write the debriefing pages to the file, and close the file in order to create the complete debriefing chart.

In embodiments, the display module 45 is configured to copy the generated debriefing chart to the Web server (see e.g., 30 in FIG. 1) so that it can be downloaded and opened by authorized users (e.g., through a browser of a user computer 10) as will be appreciated by those skilled in the art. It is further noted that the display module 45 is configured to enable the debriefing chart to be displayed in a variety of formats, including but not limited to, display on computer terminal(s) or monitor(s), hand-held displays, overhead displays, display on a printout from a printer, and/or output to a data file for storage on computer-enabled media.

The user interface module 46 is configured to allow users to interact with debriefing tool 40 (e.g., according to authorization level). For example, upon the user's first encounter with the debriefing tool 40, the user interface may present a log-in page to receive user credentials. In embodiments, the user interface module 46 is configured to allow a user (e.g., a source selection team member) to enter evaluation data, modify evaluation data, generate debriefing charts (e.g., by selecting an icon for running the debriefing chart generation process), and/or view the generated debriefing chart, etc.

As further shown in FIGS. 5a-c, the modules of the debriefing tool 40 are preferably in communication with one another via communication means 49. Communication means 49 may comprise any form of physical and/or logical communication such as wired or wireless inter-processor communication and/or intra-processor communication via internal memory, etc.

Additionally, the debriefing tool 40 is comprised of any combination of hardware and/or software and configured in any manner suitable for performing the disclosed embodiments. Moreover, it is understood that the modules in FIGS. 5a-c may communicably reside on one or more servers or host processors 30 in the same, or separate, locations. According to embodiments, the modules are based on an interoperable, plug-in architecture. Thus, other modules may be easily included to provide additional features depending upon various applications and configurations. The modules may further include custom macros, subroutines, logic, etc. implemented using commercially available software such as Jakarta, Tomcat, MySQL™, MS SQL Server™, Oracle™, Java™, Java™ servlets, JavaScript™, etc. It will further be appreciated by those skilled in the art that the modules may be implemented in various configurations are not limited to the configurations disclosed herein, and that the different modules may be combined in various manners to perform the functions disclosed herein. According to a further aspect, the software instructions for the modules may reside in whole, or in part, on a computer-readable medium. Examples of computer-readable media include, but are not limited to any fixed or removable devices such as hard drives, CDs, DVDs, magneto-optical storage, memory sticks, and the like.

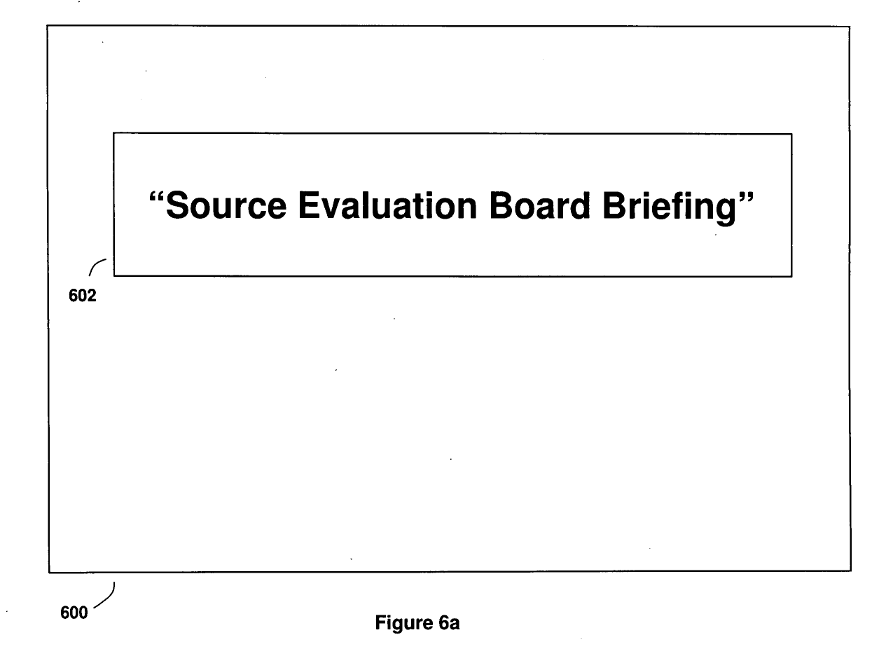

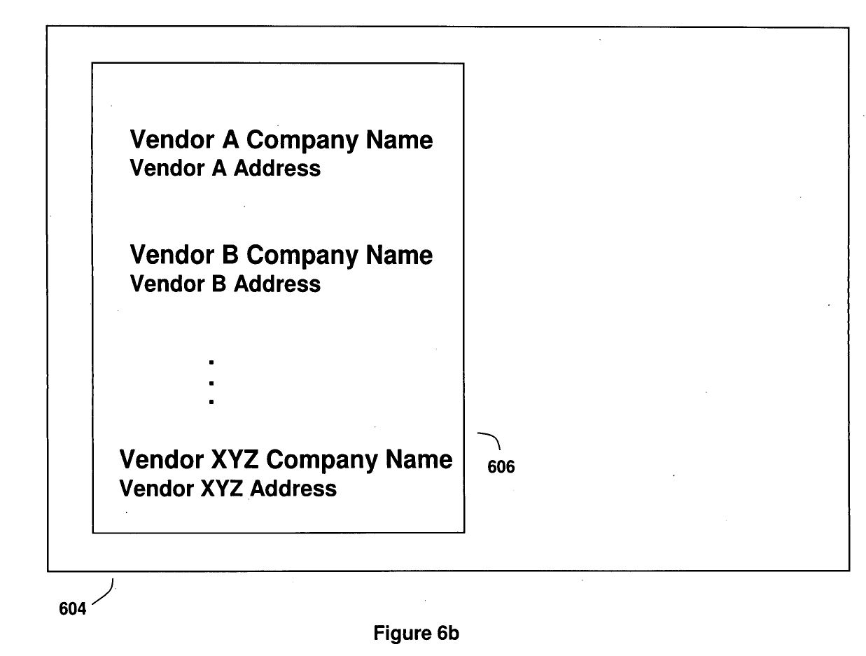

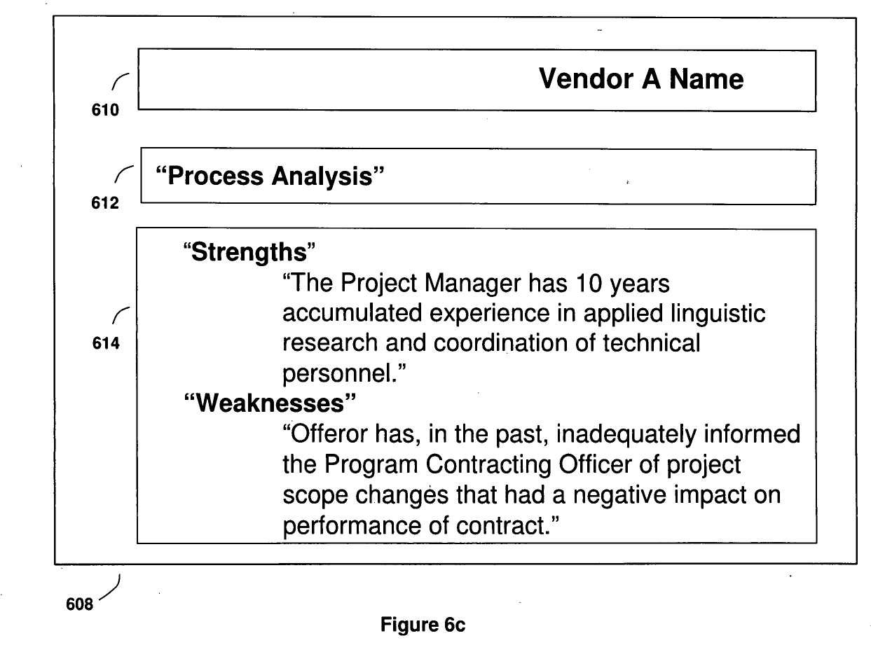

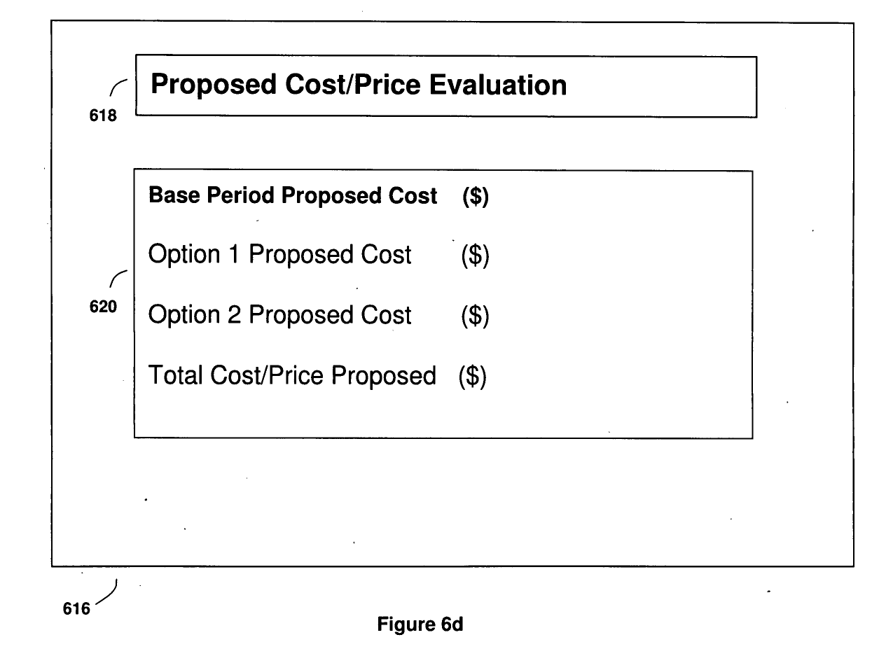

FIGS. 6a-e illustrate exemplary debriefing chart slides generated according to principles of the present disclosure. FIG. 6a depicts a generated debriefing chart slide 600 displayed to a user and comprising a title area (as depicted by box 602). The title may comprise, for example, the name of the source selection and may be obtained from data source 60 and/or edited by an authorized user. In the debriefing chart slide (depicted by box 604) in FIG. 6b, the names and addresses of candidates or vendors are obtained e.g., from data source 60 and displayed, for example, in area 606. FIG. 6c illustrates slide 608 generated for each vendor that displays: e.g., Vendor Name (as depicted by box 610), Factor/Sub-Factor Name (as depicted by box 612) and/or Summarized Comments (as depicted by box 614). For example, displayed Factor names may include: Staffing/Resumes; Facilities; Program Management; Quality Control, etc. In addition, displayed sub-factor names for e.g., Program Management may include: Process Analysis; Tasking Analysis; Staff Availability; Resource Availability, etc. In addition, summarized comments for each sub-factor may further be divided e.g., into strengths and weaknesses as illustrated in FIG. 6c. FIG. 6d depicts a slide 616 illustrating vendor cost data. The Cost Factor Name is displayed (as depicted by box 618) and further Cost Factors/Costs are displayed e.g., at 620. According to preferred embodiments, specific or predetermined settings are associated with the above described slides such as: margin, font size, font type, placement of text, etc. depending upon different applications.

To access the Web-based debriefing tool 40, a user computer 10 connects to the server(s) 30 over network 20. For example, a user computer 10 can access the server(s) 30 over the Internet using HTTP, FTP, SMTP, WAP protocols, or the like. In embodiments, a user may access debriefing charts by entering a corresponding URL/URI in the browser of user computer 10. In addition, the server(s) 30 and/or data source(s) 60 preferably comprise security mechanisms for restricting access to the Website to authorized users only. Access to debriefing charts may be limited based on user authorization level, as will be appreciated by those skilled in the art. For example, if the user is an evaluator, or part of the source selection team, they may have read/write access to both the debriefing tool 40 and the entire generated debriefing chart. On the other hand, a vendor may only have limited access to read a debriefing chart with respect to the proposal submitted by that vendor.

In embodiments, upon a first visit to the Website, vendors may encounter a log-in page and be prompted to enter a username and password, digital certificate, (or another secure form of authentication). Once registered, the vendor may visit the portal at any time and perform authentication to establish a secure connection using SSL or TLS, a virtual private network (VPN), or the like. By accessing debriefing charts relevant to the proposal they submitted, vendors are able to quickly gain valuable feedback to apply to future proposals. Additionally, evaluators may be relieved from the duty to schedule times to meet with vendors in order to provide the debriefing information in person—saving time and money for both evaluators and vendors.

While preferred embodiments have been discussed, it is understood that such configurations are exemplary only and it will be apparent to those skilled in the art that various modifications and variations can be made without departing from the scope or spirit of the invention. Therefore, the invention is not limited to the exact disclosed embodiments or examples, but rather all suitable modifications may be considered to fall within the scope of the invention and appended claims.

1. A computerized method for generating and displaying a debriefing chart to authorized user(s) for a proposal selection process in which one or more winning proposal(s) are selected from a group of submitted proposals, the method comprising:
a) using a first processor to obtain summarized evaluation data for one or more of the submitted proposals;
b) using a second processor to format the summarized data according to predetermined settings;
c) using a third processor to generate a debriefing chart using the formatted, summarized data; and
d) displaying the generated debriefing chart to authorized user(s).

2. The method of claim 1, wherein the step of using a first processor to obtain summarized evaluation data includes summarizing the evaluation data.

3. The method of claim 1, wherein the step of using a first processor to obtain summarized evaluation data includes obtaining data from one or more of a: database, datastore, and data file.

4. The method of claim 1, wherein the step of using the second processor to format the summarized data is performed after one or more predetermined conditions have been met.

5. The method of claim 4, wherein one predetermined condition is that evaluation data has been obtained for all proposals in the group.

6. The method of claim 4, wherein one predetermined condition is that the evaluation data has been through a consensus process.

7. The method of claim 1, wherein the formatting step includes formatting the evaluation data according to at least one content-specific parameter.

8. The method of claim 7, wherein at least one content-specific parameter corresponds to winning proposal(s) and wherein the generating and displaying steps include generating and displaying one or more debriefing pages or slides indicating the winning proposal(s).

9. A computer program product residing on a computer readable medium and containing instructions, that when executed by a computer, cause the computer to automatically generate a debriefing chart for a proposal selection process in which one or more winning proposals are selected from a group of submitted proposals, the instructions comprising:
a) obtaining summarized evaluation data for one or more of the proposals;
b) formatting the summarized data according to predetermined settings;
c) generating a debriefing chart using the formatted, summarized data; and
d) displaying the generated debriefing chart to authorized user(s).

10. The computer program product of claim 9, wherein the instructions for obtaining summarized evaluation data further include instructions for summarizing the evaluation data.

11. The computer program product of claim 9, wherein the instructions for obtaining summarized evaluation data include obtaining data from one or more of a: database, datastore, and data file.

12. The computer program product of claim 9, wherein the instructions for formatting the summarized data are executed after one or more predetermined conditions have been met.

13. The computer program product of claim 12, wherein one predetermined condition is that evaluation data has been obtained for all proposals in the group.

14. The computer program product of claim 12, wherein one predetermined condition is that the evaluation data has been through a consensus process.

15. The computer program product of claim 9, wherein the instructions for formatting include instructions for formatting the evaluation data according to at least one content-specific parameter.

16. The computer program product of claim 15, wherein at least one content-specific parameter corresponds to winning proposal(s) and further including instructions for generating and displaying one or more debriefing page(s) or slide(s) indicating the winning proposal(s).

17. A computerized debriefing tool for generating and displaying a debriefing chart to authorized user(s) for a proposal selection process in which one or more winning proposals are selected from a group of submitted proposals, the debriefing tool comprising:
a) a first processor that obtains summarized evaluation data for one or more of the submitted proposals;
b) a second processor that formats the summarized data according to predetermined settings;
c) a third processor that generates a debriefing chart using the formatted, summarized data; and
d) a display that displays the generated debriefing chart to authorized user(s).

18. The debriefing tool of claim 17, wherein the first processor is configured to summarize the evaluation data.

19. The debriefing tool of claim 17, wherein the second processor is configured to format the evaluation data according to at least one content-specific parameter.

20. The debriefing tool of claim 19, wherein at least one content-specific parameter corresponds to winning proposal(s) and wherein the third processor is configured to generate one or more debriefing page(s) or slide(s) indicating the winning proposal(s).
